(19) United States
(12) Patent Application Publication
(10) Pub. No.: US 2003/0185208 A1
(43) Pub. Date: Oct. 2, 2003

(54) Method and apparatus for changing path maximum transmission unit on dynamic IP network

(75) Inventors: Hak-Goo Lee, Suwon-si (KR); Young-Keun Kim, Incheon Metropolitan-City (KR); Sun-Woo Kim, Suwon-si (KR); Jae-Hwang Lee, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO.,LTD.

(21) Appl. No.: 10/401,536

(22) Filed: Mar. 31, 2003

Related U.S. Application Data
(60) Provisional application No. 60/368,329, filed on Mar. 29, 2002.

(30) Foreign Application Priority Data
Jun. 18, 2002 (KR) 2002-34132

(51) Int. Cl. H04L 12/28

(52) U.S. Cl. 370/389

(57) ABSTRACT

A method and apparatus for more efficiently operating a network environment, and more particularly, for discovery and change of a path maximum transmission unit (PMTU) between a source node and a destination node on a dynamic IP network is provided. A PMTU discovery packet is generated with a maximum transmission unit (MTU) information storage space in which an MTU value on a routing path between the source node and the destination node is stored, wherein the generated PMTU discovery packet is transmitted to the destination node. If a response packet to the PMTU discovery packet from the destination node is received, the PMTU is changed according to MTU information contained in the response packet. The MTU value stored in the MTU information storage space is compared with a link MTU value on a path which the PMTU discovery packet traverses, and the smaller one of the stored MTU value and the link MTU value on the path which the packet traverses is stored in the MTU information storage space. According to the method, a PMTU can be determined in a shorter time, and it is possible to minimize the use of network resources, compared to the prior art PMTU changing method.

### CROSS-REFERENCE TO RELATED APPLICATIONS

This application claims benefit from U.S. Provisional Application No. 60/368,329 filed Mar. 29, 2002, the contents of which are incorporated herein by reference, and claims priority from Korean Patent Application No. 2002-34132 filed Jun. 18, 2002, the contents of which are incorporated herein by reference.

### BACKGROUND OF THE INVENTION

1. Field of the Invention

The present invention relates to a method and apparatus for more efficiently operating a network, and more particularly, to a method and apparatus for performing discovery of a maximum transmission unit (MTU) on a path in a dynamic network environment, and changing a path MTU (PMTU) according to the discovered MTU with higher efficiency.

2. Description of the Related Art

As the number of the Internet users has been rapidly increasing recently, the 32-bit address system in networks based on the conventional Internet Protocol version 4 (IPv4) has shown the limits of Internet protocol (IP) addresses and functional restrictions. To solve these problems, Internet Protocol version 6 (IPv6) by which a variety of services can be provided through diverse expanded functions with a 128-bit address system has been proposed.

In the IPv4, when the size of a packet is greater than a link MTU, a router located on a routing path performs fragmentation of a packet. However, in IPv6 unlike in IPv4, if a packet is once transmitted by a source node, a node in the middle of a path does not perform fragmentation of the packet. Instead, the source node searches for a minimum MTU on a path, fragments packets according to the discovered MTU, and transmits the fragmented packets.

Accordingly, when an IPv6 node, that is, a source node, is desired to transmit data to a destination node in a remote location, a link MTU of a path through which a packet is transmitted is first discovered. That is, a path MTU (hereinafter referred to as “PMTU”) that is a minimum link MTU in a routing path between the source node and the destination node should be determined.

According to the prior art PMTU discovery method, when a source node first transmits a packet, the source node fragments the packet in units each having the size of a next-hop link MTU and transmits the fragmented packet.

When the size of a packet transmitted from the source node is greater than a link MTU between hops in the routing path, this packet is discarded, and an Internet Control Message Protocol (ICMP)-Packet Too Big message containing next-hop link MTU information is generated and transmitted to the source node. Using the MTU information of the ICMP-Packet Too Big message, the source node fragments the packet again and transmits it again. This routine is repeated until the packet arrives at the destination node without being discarded after being transmitted by the source node.

FIG. 1 is a diagram showing a process for changing a PMTU by applying a prior art method for PMTU discovery when a routing path between a source node 110 and a destination node 170 changes from a path connecting a first node 120, a second 130, a third node 140, and the destination node 170, to a path connecting the first node 120, a fourth node 150, a fifth node 160, and the destination node 170 in a dynamic network environment.

In the prior art method, while a packet is being transmitted, a PMTU may change if there is a change of a routing path according to the dynamic network environment. Therefore, when a PMTU is maintained for a predetermined time, the prior art PMTU discovery method described above is used to discover the PMTU of the current routing path, and according to the discovered result, the PMTU is increased. However, in this case, an ICMP error message of IPv6, that is, an error message such as an ICMP-Packet Too Big message, is unnecessarily generated such that network resources are wasted.

Referring to FIG. 1, a method for discovering and changing a PMTU of a current routing path according the prior art PMTU discovery method in order to change a PMTU, and an apparatus thereof will now be explained.

First, when a routing path between the source node 110 and the destination node 170 changes from a path connecting the first node 120, the second node 130, the third node 140, and the destination node 170, to a path connecting the first node 120, the fourth node 150, the fifth node 160, and the destination node 170 in a dynamic IP network environment, the PMTU values increase from MTU=2 to MTU=3, but the current source node 110 continuously fragments packets according to MTU=2, and transmits the packets.

Using a timer (not shown), if a predetermined time passes, the source node 100 generates a packet \mathring{1} (MTU=6) based on the MTU value 6 and transmits the packet to the next node, the first node 120.

Since the size of the received packet \mathring{1} (MTU=6) is greater than the next-hop link MTU value 5, the first node 120 discards the received packet \mathring{1} (MTU=6), and generates an ICMP error message containing next-hop link MTU information, which is MTU=5. That is, the first node 120 generates an ICMP Packet Too Big message \mathring{2} (MTU=5), and transmits the message to the source node 110.

The source node 110 fragments the packet again according to the next-hop link MTU value, that is, MTU=5, of the first node 120 contained in the received ICMP error message \mathring{2} (MTU=5) transmitted by the first node 120, and transmits the re-fragmented packet \mathring{3} (MTU=5) to the destination node 170.

Since the size of the received packet \mathring{3} (MTU=5) is greater than the next-hop link MTU value, that is, MTU=4, the fourth node 150 discards the received packet \mathring{3} (MTU=5), generates an ICMP error message \mathring{4} (MTU=4) containing the next-hop link MTU information, and transmits the message to the source node 110. Like the previous step, the source node 110 fragments the packet to satisfy the new link MTU=4, and transmits the fragmented packet \mathring{5} (MTU=4) to the destination node 170.

As in nodes 1 and 4, since the size of the received packet \mathring{5} (MTU=4) is greater than the next-hop link MTU value, that is, MTU=3, the fifth node 160 discards the received packet \mathring{5} (MTU=4), generates an ICMP error message \mathring{6} (MTU=3) containing the next-hop link MTU information, and transmits the message to the source node 110. Like the previous step, the source node 110 fragments the packet to satisfy the new link MTU, and transmits the fragmented packet \mathring{7} (MTU=3) to the destination node 170.

Thus, in the prior art method for increasing a PMTU, in order to discover a PMTU of a current routing path and change the PMTU, much time is spent and network resources are unnecessarily wasted.

### SUMMARY OF THE INVENTION

To solve the above problems, the present invention provides a method and apparatus for more efficiently discovering a PMTU of a current routing path in a dynamic network environment and changing a PMTU according to the discovered PMTU.

According to an aspect of the present invention, there is provided a method for changing a path maximum transmission unit (PMTU) between a source node and a destination node on a dynamic Internet protocol (IP) network, the method comprising: (a) generating a PMTU discovery packet having a maximum transmission unit (MTU) information storage space in which an MTU value on a routing path between the source node and the destination node is stored; (b) transmitting the generated PMTU discovery packet to the destination node; and (c) if a response packet to the PMTU discovery packet from the destination node is received, changing the PMTU according to MTU information contained in the response packet, wherein the MTU value stored in the MTU information storage space is compared with a link MTU value on a path which the PMTU discovery packet traverses, and the smaller one of the stored MTU value and the link MTU value on the path which the packet traverses is stored in the MTU information storage space.

It is preferable that the PMTU discovery packet which is generated in step (a) is generated if a current PMTU value is maintained for a predetermined time.

It is preferable that in step (a) a next-hop link MTU value of the source node is stored in the MTU information storage space.

It is preferable that step (c) comprises step (c1) in which if the PMTU discovery packet arrives at the destination node, a packet containing the MTU value stored in the MTU information storage space of the PMTU discovery packet is generated, and the packet is transmitted to the source node.

According to another aspect of the present invention, there is provided an apparatus for changing a path maximum transmission unit (PMTU) between a source node and a destination node on a dynamic IP network, the apparatus comprising: a PMTU discovery packet generation unit which generates a PMTU discovery packet having an MTU information storage space in which a maximum transmission unit (MTU) value on a routing path between the source node and the destination node is stored; a transmission unit which transmits the generated PMTU discovery packet to the destination node; and a PMTU changing unit which, if a response packet to the PMTU discovery packet from the destination node is received, changes the PMTU according to MTU information contained in the response packet, wherein the MTU value stored in the MTU information storage space is compared with a link MTU in a path which the PMTU discovery packet traverses, and the smaller one of the stored MTU value and the link MTU value in the traverse path is stored in the MTU information storage space.

It is preferable that the PMTU discovery packet is generated if the current PMTU value is maintained for a predetermined time.

It is preferable that the size of the PMTU discovery packet is equal to or less than the size of the current PMTU.

It is preferable that a next-hop link MTU value of the source node is stored in the MTU information storage space.

It is preferable that the PMTU discovery packet is a packet which complies with Internet Protocol version 6 and has a hop-by-hop option header that is an extension header.

It is preferable that an option type field of the hop-by-hop option header of the PMTU discovery packet stores information indicating that if a node in the middle of a routing path does not recognize the option type field of the PMTU discovery packet, the PMTU discovery packet should be discarded.

It is preferable that the information indicating that the PMTU discovery packet should be discarded is located in the highest 2 bits stored in the option type field.

It is preferable that the option type field stores information indicating whether or not it is possible to change MTU information stored in the MTU information storage space.

It is preferable that the information indicating whether or not it is possible to change MTU information is located in the third highest bit stored in the option type field.

It is preferable that the field in which the MTU information is stored is an option data field in the option field of the hop-by-hop header of IPv6.

### BRIEF DESCRIPTION OF THE DRAWINGS

The above objects and advantages of the present invention will become more apparent by describing in detail preferred embodiments thereof with reference to the attached drawings in which:

FIG. 1 is a diagram showing a prior art method for changing a path maximum transmission unit (PMTU);

FIG. 2 is a diagram of a basic header of Internet Protocol version 6 (IPv6) used in the present invention;

FIG. 3 is a diagram of a basic structure of an Internet Control Message Protocol version 6 (ICMPv6) extension header used in the present invention;

FIG. 4A is a diagram showing a basic structure of a hop-by-hop option header used in the present invention;

FIG. 4B is a diagram of the structure of an “Options” field in the hop-by-hop option header shown in FIG. 4A;

FIG. 5A is a diagram of the structure of an “Options” field in a hop-by-hop option header constructed according to a preferred embodiment of the present invention;

FIG. 5B is a diagram of the structure of an “Options” field in a hop-by-hop option header constructed according to another preferred embodiment of the present invention;

FIG. 6 is a diagram of the structure of a packet containing an OIP option according to the present invention;

FIG. 7A is a diagram showing a PMTU changing method according to a preferred embodiment of the present invention;

FIG. 7B is a diagram showing a PMTU changing method according to another preferred embodiment of the present invention;

FIG. 8 is a diagram showing a storage space shape of a node according to the present invention;

FIG. 9A is a diagram showing a basic structure of an ICMPv6 message used in the present invention;

FIG. 9B is a diagram showing a basic structure of an ICMP-Packet Too Big message used in the present invention;

FIG. 10A is a diagram showing a modified ICMP-Packet Too Big message used in a PMTU discovery method according to the present invention; and

FIG. 10B is a diagram showing a newly defined ICMP-PMTUD Minimizing Packet used in a PMTU discovery method according to the present invention.

### DESCRIPTION OF THE PREFERRED EMBODIMENTS

First, terminologies used in this specification are defined as follows:

node: a device that implements IPv6.

router: a node that forwards IPv6 packets not explicitly addressed to itself.

host: any node that is not a router.

upper layer: a protocol layer immediately above IPv6. For example, transport protocols such as Transmission Control Protocol (TCP) and User Datagram Protocol (UDPO, control protocols such as ICMP path maximum transmission unit discovery (PMTU) Minimizing Packet: a newly defined ICMP information message.

link: a communication facility or medium over which nodes can communicate at the link layer.

packet: an IPv6 header plus a payload.

link MTU: the maximum transmission unit.

path: the set of links traversed by a packet between a source node and a destination node.

path MTU (PMTU): the minimum link MTU of all the links in a path between a source node and a destination node.

Referring to the attached drawings, preferred embodiments of the present invention will now be explained.

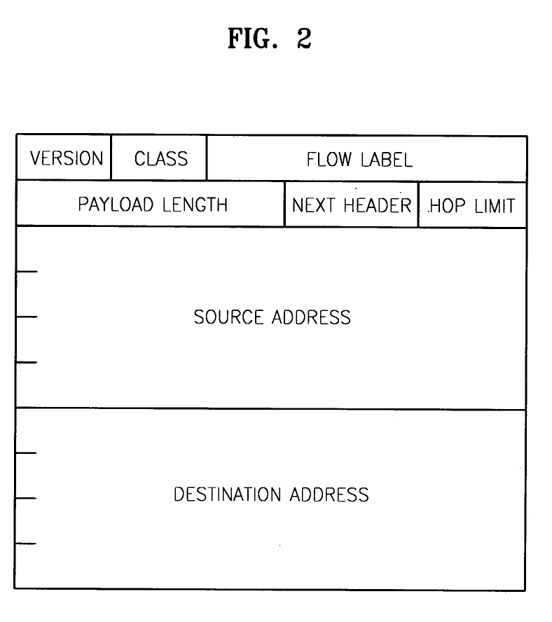

FIG. 2 is a diagram of a basic header of IPv6 used in the present invention. All packets of IPv6 begin with a basic header formed with 40 bytes. “Version” of FIG. 2 indicates the version of IP, and “Payload Length” indicates the length of an IP packet in units of bytes. “Next Header” indicates which extension header follows the basic header of IPv6, and “Hop Limit” is used to restrict in units of hops a distance for transmitting an IP packet. “Source Address” and “Destination Address” indicate the address of a host transmitting a packet and the address of a destination to which the packet is to be transmitted, respectively. The length of the each address is 128 bits.

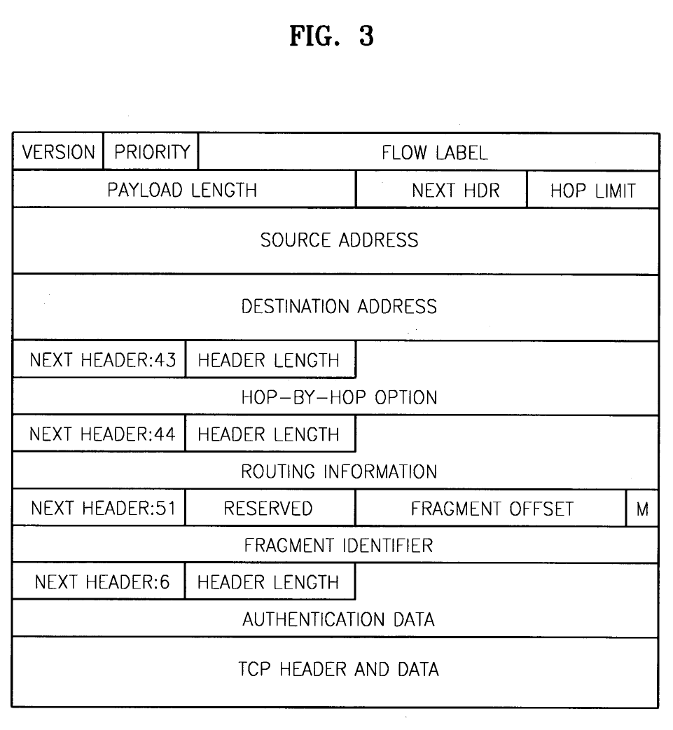

FIG. 3 is a diagram of an extension header in IPv6 used in the present invention.

The extension header in IPv6 is retrieved in the order in which the “Next Header” field of a basic header is first retrieved, and then a next extension header of a value indicated by the “Next Header” field is retrieved. In the structure of the extension header, the first byte indicates the value of a next extension header and the second byte indicates the length of the present extension header. Table 1 lists various values of a next header and corresponding extension headers.

TABLE 1

| Next header value | Type of option header |
|---|---|
| 0 | Hop-by-hop option header |
| 43 | Routing header |
| 44 | Fragment header |
| 51 | Authentication header |
| 58 | ICMP |
| 59 | No next header |
| 60 | Destination option header |

The order in which option headers are shown in Table 1 is determined by considering that when apparatuses of nodes located in the middle of a routing path through which packet is transmitted retrieve the header part of the packet being transmitted, the apparatuses retrieve from the beginning part only to the needed part of the packet. The routers supporting IPv6 refer to the hop-by-hop option header and routing information.

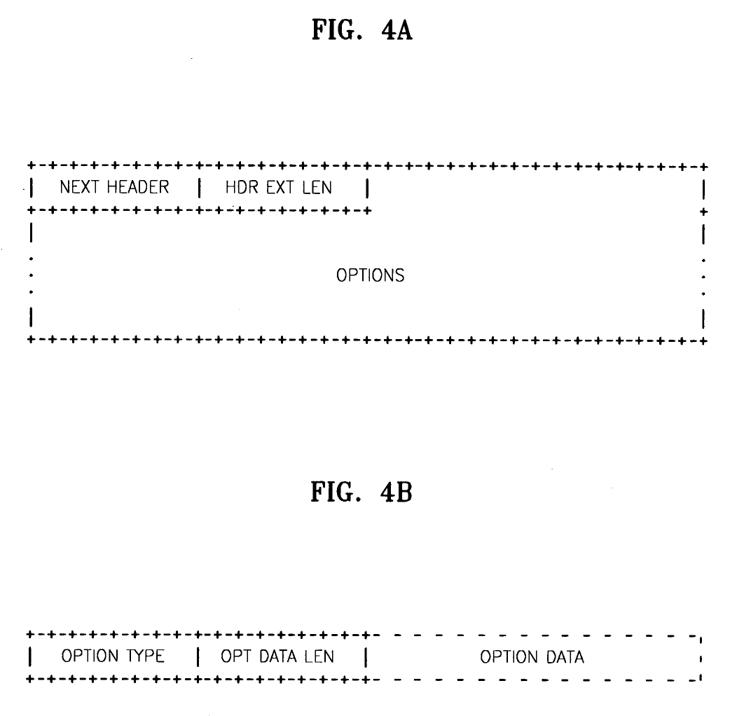

FIG. 4A is a diagram showing a basic structure of a hop-by-hop option header. The “Next Header” field is used to distinguish the type of a header immediately following the hop-by-hop option header. A “Hdr Ext Len” field indicates the length of the hop-by-hop option header. An “Options” field is a variable-length field and stores option information related to the hop-by-hop option header.

FIG. 4B is a diagram of the structure of the “Options” field in the hop-by-hop option header shown in FIG. 4A. An “Option Type” field stores option type information, an “Opt Data Len” field stores the length of an option data field of this option, and an “Option data” field is a variable-length field and stores option type-specific data.

The highest 2 of the “Option Type” field indicates the type of measures which node in the middle of the routing path takes on the present packet when the node cannot recognize the option type stored in the “Option Type” field. For example, if the highest 2 bits of the “Option Type” field are 01 and the node in the middle of the routing path cannot recognize the option type stored in the “Option Type” field, this node discards the present packet.

The third highest bit of the “Option Type” field indicates whether or not information stored in the “Option Data” field of the hop-by-hop header changes in the middle of the routing path. For example, if the third highest bit of the “Option Type” field is 0, it indicates that the option data information of the “Option Data” field cannot change and if the bit is 1, it indicates that the option data information of the “Option Data” field can change.

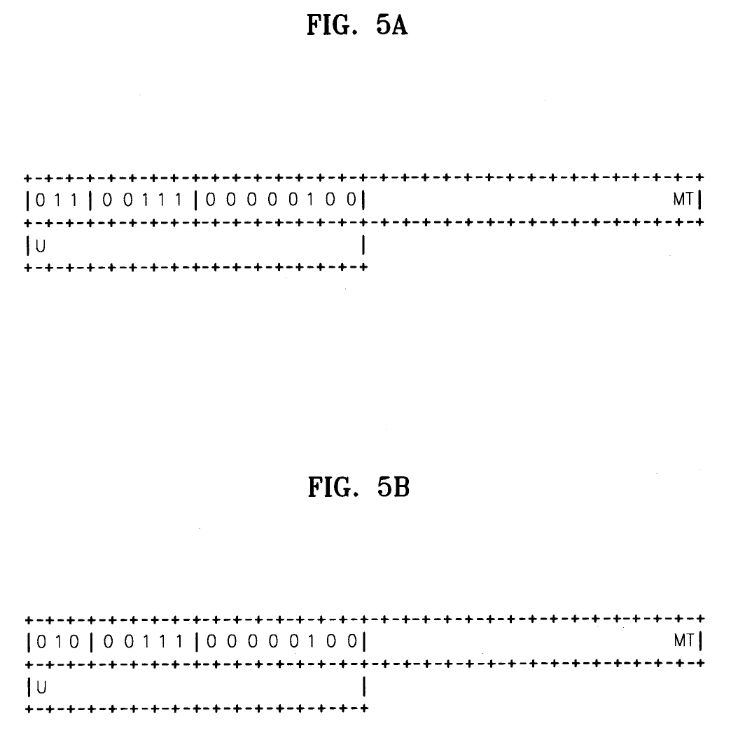

FIG. 5A is a diagram of the structure of the “Options” field in a hop-by-hop option header constructed according to a preferred embodiment of the present invention when a packet is transmitted from a source node to a destination node.

Binary information value “0 1 1 0 0 1 1 1” (i.e., “103” decimal) is stored in the “Option Type” field of FIG. 5A. The highest 2 bits “0 1” indicate that when a node in the middle of the routing path cannot recognize the option type stored in the “Option Type” field, for example, the option “103” that indicates the optimization of increasing the PMTU option (hereinafter referred to as an “OIP option”), the packet in which the OIP option is inserted should be discarded. This is to prevent unnecessary wastage of network resources when an apparatus of a node in the middle of the routing path does not support the OIP option method according to the present invention, and at the same time to enable a PMTU increase using the prior art PMTU discovery method.

Also, the third highest bit “1” of the “Option Type” field indicates that option data information of the “Option Data” field can change. In addition, the value “0 1 1 0 0 1 1 1” (i.e., “103” decimal), stored in the “Option Type” field indicates that an OIP option of a case where a routing path from the source node to the destination node is inserted into the present packet.

FIG. 5B is a diagram of the structure of the “Options” field in a hop-by-hop option header constructed according to another preferred embodiment of the present invention when a packet is transmitted from a destination node to a source node.

Binary information value “0 1 0 0 0 1 1 1” (i.e., “71” decimal) is stored in the “Option Type” field of FIG. 5B. The highest 2 bits “0 1” indicates that when a node in the middle of the routing path cannot recognize the option type stored in the “Option Type” field, for example, the option “71” indicating the OIP option, the packet in which the OIP option is inserted should be discarded. This is to prevent unnecessary wastage of network resources when an apparatus of a node in the middle of the routing path does not support the OIP option method according to the present invention, and at the same time to enable a PMTU increase using the prior art PMTU discovery method.

Also, the third highest bit “0” of the “Option Type” field indicates that option data information of the “Option Data” field cannot change. In addition, the binary value “0 1 0 0 0 1 1 1” (i.e., “71” decimal) stored in the “Option Type” field indicates that an OIP option of a case where a routing path is from the destination node to the source node is inserted into the present packet.

Also, the binary value “0 0 0 0 0 1 0 0” (i.e., “4” decimal) stored in the “Opt Data Len” field indicates that the length of the option data field of this option is 4 octets in total. A minimum link MTU of the routing path is stored in this 4-octet-long option data field.

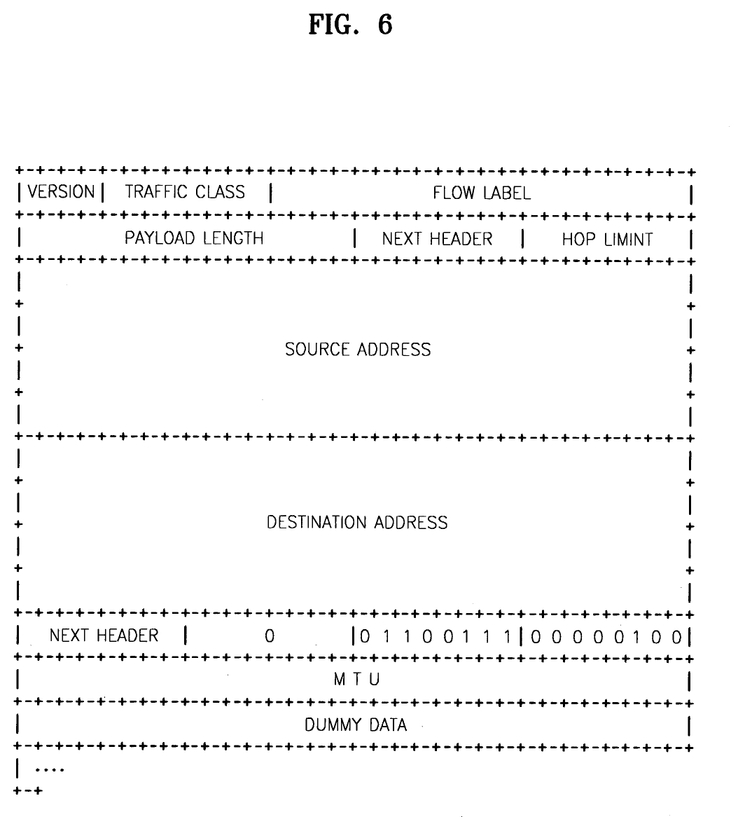

FIG. 6 is a diagram of the structure of a packet containing an OIP option according to the present invention.

Thus, according to the optimized PMTU increasing method according to the present invention, when time is up according to a timer setting and the source node desires to increase the PMTU, the source node generates a packet in which the OIP option described above is inserted (hereinafter, referred to as an “OIP packet”) with the size of the existing PMTU, and transmits the packet to the destination node.

Here, in the “Opt Data Len” field (hereinafter, referred to as an “MTU field”) of the OIP option, the next-hop link MTU value of the source node is stored.

While this OIP packet traverses each node on the routing path between the source node and the destination node, the apparatus of each node, for example, a router, performs the following operation.

1. When the node cannot recognize the option type stored in the “Option Type” field of the OIP packet, the router discards the OIP packet.

2. When the node recognizes the option type stored in the “Option Type” field of the OIP packet, the router compares the MTU value stored in the MTU field of the OIP packet with the next-hop link MTU.

3. The router stores the smaller one of the compared values in the MTU field of the OIP packet.

After this operation is performed at every node until the destination node, the minimum link MTU value between the source node and the destination node, that is, the PMTU value, is stored in the MTU field of the OIP packet.

If the destination node receives the OIP packet storing the PMTU value, the destination node immediately transmits the value to the source node. The source fragments the packet according to the received PMTU value and transmits the packet.

Accordingly, it is possible to prevent generation of unnecessary error messages and wastage of network resources that occur in the prior art PMTU increasing method by which a PMTU unconditionally increases as time passes.

Also, when the source node does not receive a response packet to the OIP packet from the destination node even after a predetermined time passes after transmission of the OIP packet, the source node fragments the packet according to the PMTU value which increases based on the prior art PMTU increasing method, and transmits the packet.

Accordingly, even when a node in a routing path between the source node and the destination node cannot recognize the OIP packet and discards the OIP packet, it is possible to increase the PMTU according to the prior art PMTU increasing method such that the compatibility with the prior art PMTU increasing method is maintained.

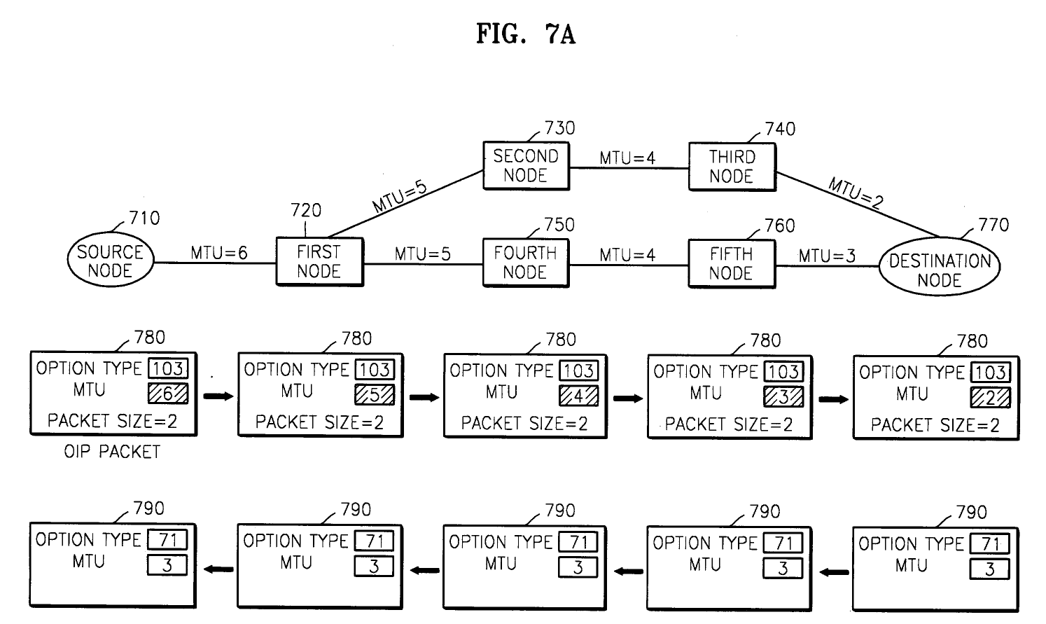

FIG. 7A is a diagram showing a preferred embodiment of a PMTU changing method according to the present invention.

First, a PMTU changing method and apparatus according to the present invention which is applied to a case when a routing path between a source node 710 and a destination node 770 in a dynamic IP network environment changes from a path connecting a first node 720, a second node 730, a third node 740, and the destination node 770, to a path connecting the first node 720, a fourth node 750, a fifth node 760, and the destination node 770, that is, when the PMTU value increases from MTU=2 to MTU=3, will now be explained.

When the present PMTU value is maintained for a predetermined time, the source node 710 with using a timer (not shown) generates an OIP packet 780 according to the present invention and transmits the OIP packet to the destination node 770.

In an embodiment according to the present invention, if an ICMP-Packet Too Big message is not received for a predetermined time, the source node generates an OIP packet 780 having the size of the existing PMTU, that is, MTU=2, and transmits the packet. However, it is also possible to selectively generate an OIP packet having a size less than the present PMTU, or to generate an OIP packet if other predetermined conditions are satisfied and to transmit the packet.

Using another timer (not shown), the source node 710 transmits the OIP packet and at the same time measures the time so that a PMTU can be changed according to the prior art PMTU changing method if a response packet to the transmitted OIP packet is not received for a predetermined time because the OIP packet is lost in the routing path.

The option type number “103” is stored in the option type field of the OIP packet, and the next-hop link MTU value of the source node 710, that is, MTU=6, is stored in the MTU field. Here, the size of the OIP packet is the existing PMTU value, that is, MTU=2. This is to prevent the OIP packet from being discarded in the routing path due to the size of the packet.

The first node 720 receives the OIP packet 780 transmitted by the source node 710, and recognizes the option type. Since the third highest bit value of the option type is 1, the first node 720 compares the MTU value stored in the MTU field of the OIP packet 780 with the next-hop link MTU=5, stores the smaller of the two values, that is, MTU=5, in the MTU field, and then transmits the OIP packet 780 to the destination node 770.

The fourth node 750 receives the OIP packet 780 transmitted by the first node 720, and recognizes the option type. Since the third highest bit value of the option type is 1, the fourth node 750 compares the MTU value stored in the MTU field of the OIP packet 780 with the next-hop link MTU=4, stores the smaller of the two values, that is, MTU=4, in the MTU field, and then transmits the OIP packet 780 to the destination node 770.

The fifth node 760 receives the OIP packet 780 transmitted by the fourth node 750, and recognizes the option type. Since the third highest bit value of the option type is 1, the fifth node 760 compares the MTU value stored in the MTU field of the OIP packet 780 with the next-hop link MTU=3, stores the smaller of the two values, that is, MTU=3, in the MTU-field, and then transmits the OIP packet 780 to the destination node 770.

The destination node 770 generates an OIP packet 790 based on information stored in the received OIP packet 780, and transmits the OIP packet 790 to the source node 710.

Option type number “71”, that is, “0 1 0 0 0 1 1 1” is stored in the option type field of the OIP packet 790 and the information stored in the MTU field of the OIP packet 780 received by the destination node 770, that is, MTU=3 is stored in the MTU field.

The fifth node 760 receives the OIP packet 790 transmitted by the destination node 770, and recognizes the option type. Since the third highest bit value of the option type is 0, the fifth node 760 transmits the OIP packet 790 to the source node 710 without changing the MTU information stored in the MTU field.

The fourth node 750 receives the OIP packet 790 transmitted by the fifth node 760, and recognizes the option type. Since the third highest bit value of the option type is 0, the fourth node 750 transmits the OIP packet 790 to the source node 710 without changing the MTU information stored in the MTU field.

The first node 720 receives the OIP packet 790 transmitted by the fourth node 750, and recognizes the option type. Since the third highest bit value of the option type is 0, the first node 720 transmits the OIP packet 790 to the source node 710 without changing the MTU information stored in the MTU field.

When the source node 710 receives the OIP packet 790 storing the PMTU value, the source node 710 fragments the packet according to the PMTU value stored in the MTU field of the OIP packet 790 and transmits the packet.

Though the third highest bit value of the option type of the OIP packet 790 generated in the destination node 770 is set to 0 in the embodiment of the present invention, the bit value can be set to 1 as in the OIP packet 780.

According to the PMTU increasing method of the present invention, it is possible to prevent generation of unnecessary error messages and waste of network resources that occur in the prior art PMTU increasing method by which a PMTU unconditionally increases as time passes.

Also, when the fourth node 750 in the routing path cannot recognize the option type of the OIP packet 780 and therefore discards the OIP packet 780 in the embodiment of FIG. 7A, if the source node 710 does not receive a response OIP packet 790 to the OIP packet 780 from the destination node 770 after a predetermined time passes after transmission of the OIP packet 780, the source node 710 fragments the packet according to a PMTU value increased based on the prior art PMTU increasing method, and transmits the packet.

Accordingly, even when a node in a routing path between the source node 710 and the destination node 770 cannot recognize the OIP packet 780 and discards the OIP packet 780, it is possible to increase the PMTU according to the prior art PMTU increasing method such that the compatibility with the prior art PMTU increasing method is maintained.

FIG. 7B is a diagram showing an improved PMTU changing method which is applied to a case when a node in the middle of a routing path between the source node 710 and the destination node 770 cannot recognize the OIP packet 780 and discards the OIP packet 780.

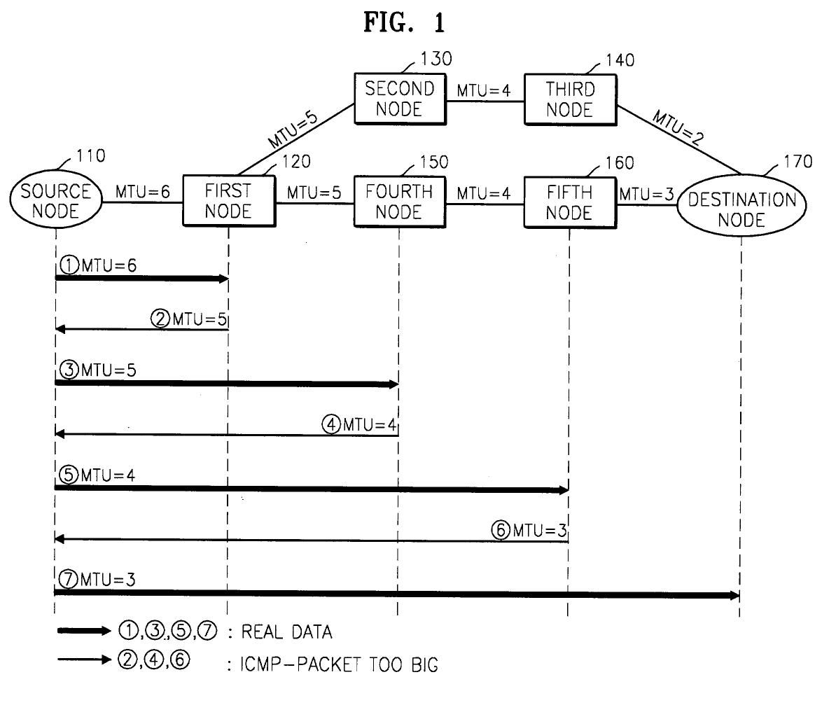

In the embodiments of FIGS. 7A and 7B, when a node in a routing path between the source node 710 and the destination node 770 cannot recognize the OIP packet 780 and discards the OIP packet 780, it is possible to increase the PMTU by using the prior art PMTU discovery method described in FIG. 1. However, if the prior art PMTU discovery method is used, relatively more time is required in discovery of the PMTU of the present routing path and network resources are unnecessarily wasted.

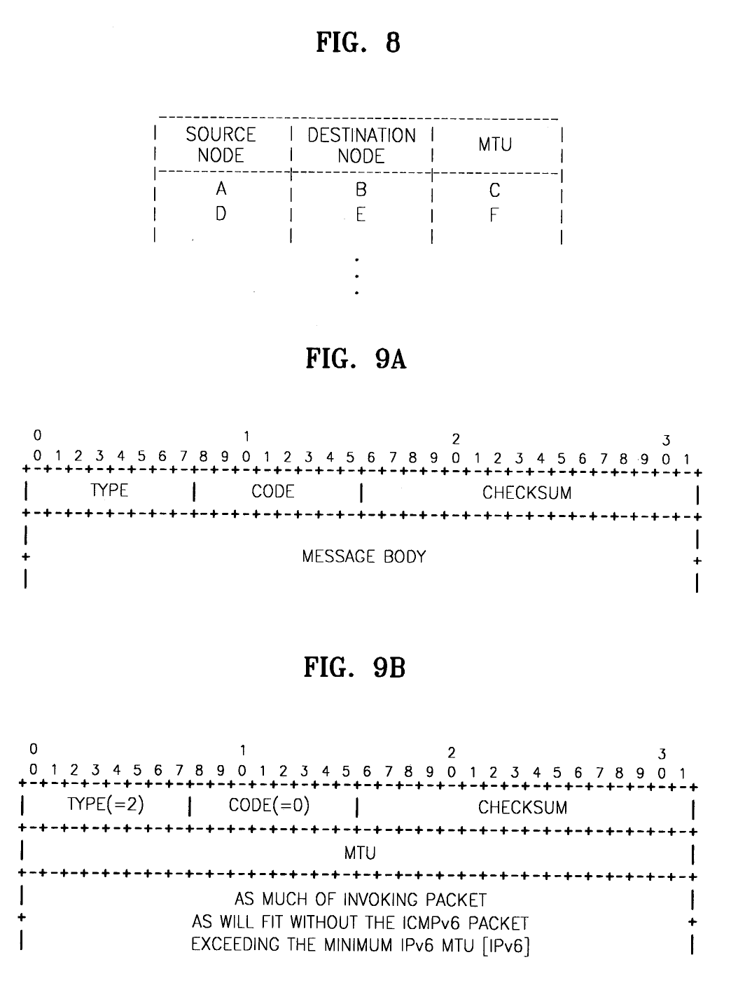

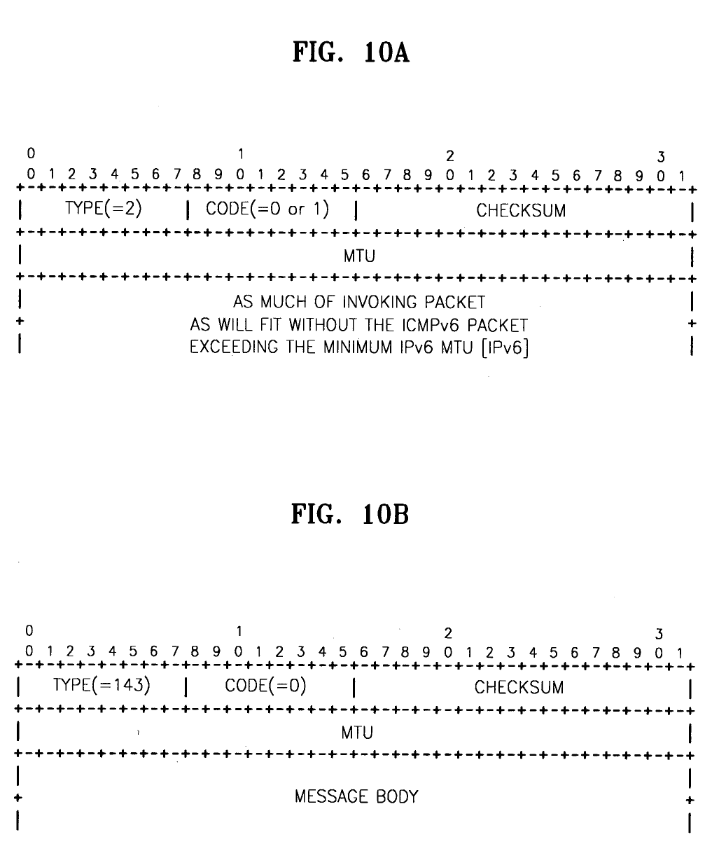

Accordingly, in an embodiment according to the present invention, ICMPv6 messages shown in FIGS. 9A and 9B are modified or newly defined, and the modified ICMP-Packet Too Big message of FIG. 10A and the ICMP-PMTUD Minimizing Packet in which is a newly defined ICMP information message shown in FIG. 10B, are used.

ICMPv6 messages shown in FIGS. 9A and 9B, the modified ICMP-Packet Too Big message of FIG. 10A and the ICMP-PMTUD Minimizing Packet, which is a newly defined ICMP information message shown in FIG. 10B, will now be explained first, and then referring to FIG. 7B, a PMTU discovery method according to a preferred embodiment of the present invention will be explained.

FIG. 9A is a diagram showing a basic structure of an ICMPv6 message used in the present invention.

In the “Type” field of the ICMPv6 message, numbers 0 to 127 are used in transmitting a message on an error, and numbers 128 to 255 are used in transmitting a message on information. In an ICMP-Packet Too Big message used in discovering a PMTU, the value in the “Type” field is 2.

FIG. 9B is a diagram showing a basic structure of an ICMP-Packet Too Big message when the value in the “Type” field of an ICMPv6 message is 2.

The value in the “Type” field of the ICMPv6 message is set to 2, and the value in a “Code” field is usually set to 0 by a sender, and is neglected in a receiver. An “MTU” field indicates a next-hop link MTU value.

The destination address of an ICMP-Packet Too Big message is copied from the source address of the IP header of the received original packet.

FIG. 10A is a diagram showing a basic structure of a modified ICMP-Packet Too Big message used in a PMTU discovery method according to the present invention. Except the fact that the value of the “Code” field is 0 or 1, the modified ICMP-Packet Too Big message shown in FIG. 10A has the same structure as that of the ICMP-Packet Too Big message of FIG. 9B.

When an ICMP-Packet Too Big message is generated for a data packet transmitted from the source node, the value in the “Code” field is set to 0. When an ICMP-Packet Too Big message is generated for a PMTUD Minimizing Packet having a “Type” field number of 143, which will be explained later, the value in the “Code” field is set to 1.

In the embodiment for explaining the PMTU discovery method according to the present invention, the value in the “Code” field is 0 or 1. However, even when the ICMP-Packet Too Big message of FIG. 9B, in which the value in the “Code” field is set to 0, is selectively used, the PMTU discovery method according to the present invention can be implemented.

FIG. 10B is a diagram showing a newly defined ICMP information message used in the PMTU discovery method according to the present invention, that is, an ICMP-PMTUD Minimizing Packet. At present, numbers 128 to 255 can be used in an ICMP information message and definitions have been determined to number 142.

In an embodiment for explaining a protocol according to the present invention, a new ICMP information message having a “Type” field number of 143 is generated and used. However, it is also possible to use the PMTU discovery method according to the present invention, by using another “Type” field number that is not 143 and is not defined at present.

The number 143 indicating the PMTUD Minimizing Packet which is newly defined according to the present invention is stored in the “Type” field of the ICMP information message shown in FIG. 10B, and the value stored in the “Code” field is set to 0.

The next-hop link MTU value is stored in the “MTU” field. The source address of the previous packet being discarded is stored as a source address value, and the destination address of the previous packet being discarded is stored as a destination address value.

The newly defined ICMP information message, that is, the PMTUD Minimizing Packet is transmitted to the destination node unlike the ICMP-Packet Too Big message. To make the size of the message meet the next-hop link MTU, the message is filled with dummy data.

When an OIP packet according to the present invention is lost in a routing path and the source node 710 cannot receive a response OIP packet for a predetermined time after transmission of the OIP packet 780, a PMTU discovery method using the modified ICMP-Packet Too Big message of FIG. 10A and the ICMP-PMTUD Minimizing Packet that is a newly defined ICMP information message shown in FIG. 10B is performed. Referring to FIG. 7B, the PMTU discovery method will now be explained. The predetermined time can be appropriately adjusted by considering the system and network environment.

The source node 710 which operates as a host shown in FIG. 7B comprises a function unit which can distinguish between 0 and 1 of the “Code” field of the modified ICMP-Packet Too Big message, and immediately after this message is received, newly defines a PMTU, and retransmits a packet satisfying the size of the new PMTU.

Each of the first node 720, the fourth node 750, and the fifth node 760 comprises a function unit which can distinguish between 0 and 1 of the “Code” field of the modified ICMP-Packet Too Big message as in the source node, and generates the modified ICMP-Packet Too Big message of FIG. 10A and the ICMP-PMTUD Minimizing Packet, which is the newly defined ICMP information message of FIG. 10B. Also, each of these nodes comprises a storage space, as shown in FIG. 6, for example, a cache (not shown), for storing the source address, destination address, and previous PMTU information stored in the discarded ICMP-PMTUD Minimizing Packet, for a predetermined time, when the ICMP-PMTUD Minimizing Packet is discarded.

The source node 710 transmits packet \mathring{1}, which is fragmented according to the next-hop link MTU value, that is, MTU=6, to the destination node 770.

Since the size of the received packet \mathring{1} is greater than the next-hop link MTU value of 5, the first node 720 generates an ICMP-Packet Too Big message containing the next-hop link MTU information, that is, MTU=5, and transmits the message to the source node 710. Here, since this message is an ICMP error message for the data packet which is originally desired to be transmitted by the source node 710, the value in the “Code” field is 0. The first node 720 also generates an ICMP-PMTUD Minimizing Packet \mathring{3} which is generated to satisfy the next-hop link MTU=5 and shown in FIG. 10B, and transmits the packet to the destination node 770.

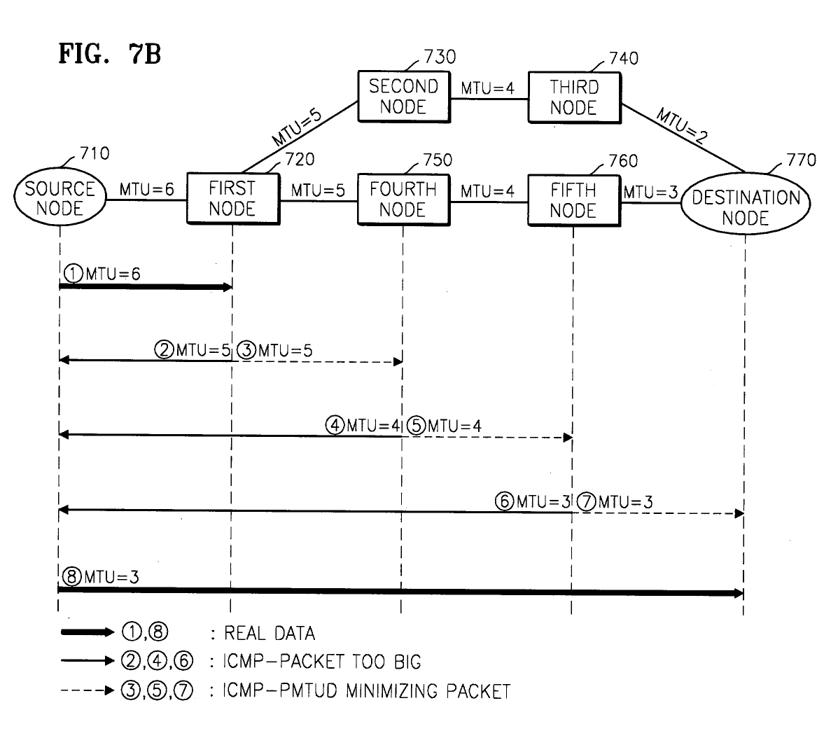

Since the size of the ICMP-PMTUD Minimizing Packet \mathring{3} which is transmitted by the first node 720 is greater than the next-hop link MTU value of 4, the fourth node 750 generates an ICMP-Packet Too Big message \mathring{4} containing the next-hop link MTU information, that is, MTU=4, and transmits the message to the source node 710. Here, since the message is about an ICMP-PMTUD Minimizing Packet, the value in the “Code” field is 1. Also, the fourth node 750 stores information stored in the “MTU”, “Source Address,” and “Destination Address” fields of the previous ICMP-PMTUD Minimizing Packet, that is, the ICMP-PMTUD Minimizing Packet \mathring{3} which is transmitted by the first node 720, into a storage space, for example, a cache having the structure shown in FIG. 8. In addition, the fourth node 750 generates an ICMP-PMTUD Minimizing Packet \mathring{5} which is generated to satisfy the next-hop link MTU=4, and transmits the packet to the destination node 770.

Since the size of the ICMP-PMTUD Minimizing Packet \mathring{5} which is transmitted by the fourth node 750 is greater than the next-hop link MTU value 3, the fifth node 760 generates an ICMP-Packet Too Big message \mathring{6} containing the next-hop link MTU information, that is, MTU=3, and transmits the message to the source node 710. Here, since the message is about an ICMP-PMTUD Minimizing Packet \mathring{5}, the value in the “Code” field is 1. Also, the fifth node 760 stores information stored in the “MTU”, “Source Address,” and “Destination Address” fields of the previous ICMP-PMTUD Minimizing Packet, that is, the ICMP-PMTUD Minimizing Packet \mathring{5} which is transmitted by the fourth node 750, into a cache, and generates an ICMP-PMTUD Minimizing Packet \mathring{7} which is generated to satisfy the next-hop link MTU=3, and transmits the packet to the destination node 770.

Meanwhile, after receiving the ICMP-Packet Too Big message \mathring{2} having a “Code” field value of 0 and which is transmitted by the first node 720, the source node 710 fragments the packet according to the link MTU value contained in the message, that is, MTU=5, and transmits the fragmented packet.

If the source node 710 receives the ICMP-Packet Too Big message \mathring{4} having a “Code” field value of 1 and which is transmitted by the fifth node 760 before the source node 710 transmits the packet fragmented according to the link MTU value, that is, MTU=5, contained in the ICMP-Packet Too Big message \mathring{2} having a “Code” field value of 0 and which is transmitted by the first node 720, the source node 710 discards the packet fragmented according to the ICMP-Packet Too Big message \mathring{2}, and again fragments the packet according to the MTU value, that is, the size of MTU=4, contained in the ICMP-Packet Too Big message \mathring{4} having a “Code” field value of 1, and transmits the fragmented packet.

If the source node 710 transmits the packet fragmented according to the MTU information, that is, MTU=5, contained in the ICMP-Packet Too Big message having a “Code” field value of 0, before the source node 710 receives the ICMP-Packet Too Big message having a “Code” field value of 1, the packet fragmented according to MTU=5 can arrive at the fourth node 750. However, since the next-hop link MTU is 4, the fourth node 750 discards the packet.

The fourth node 750 already stored information stored in “MTU”, “Source Address,” and “Destination Address” fields of the ICMP-PMTUD Minimizing Packet □ which was transmitted by the first node 720, in the cache. Since these values stored in the cache are the same as the information in the packet, the fourth node 750 does not generate a separate ICMP error message. By doing so, it is possible to prevent unnecessary use of network resources.

In the embodiments according to the present invention, it is assumed that all nodes on the routing path between the source node and destination node support the modified ICMP-Packet Too Big message of FIG. 10A and the ICMP PMTUD Minimizing Packet that is the newly defined ICMP information message of FIG. 10B, according to the present invention. However, even though some of these nodes do not support the messages according to the present invention, PMTU discovery between the source node and destination node by using the prior art PMTU discovery method is also possible.

Optimum embodiments have been explained above and are shown. However, the present invention is not limited to the preferred embodiment described above, and it is apparent that variations and modifications by those skilled in the art can be effected within the spirit and scope of the present invention defined in the appended claims.

The present invention may be embodied in a code, which can be read by a computer, on a computer readable recording medium. The computer readable recording medium includes all kinds of recording apparatuses on which computer readable data are stored.

The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can store and execute a computer readable code in a distributed mode.

As described above, when the PMTU increasing method according to the present invention is used, a PMTU can be determined in a shorter time, and it is possible to minimize the use of network resources, compared to prior art PMTU methods. Also, even though some of nodes in a routing path do not support the packet type according to the present invention, PMTU discovery between the source node and destination node can be performed by using the prior art PMTU discovery method.

What is claimed is:

1. A method for changing a path maximum transmission unit (PMTU) of a routing path between a source node and a destination node on a dynamic Internet protocol (IP) network, wherein the routing path includes a plurality of links and the PMTU corresponds to a minimum link maximum transmission unit (MTU) of links in the routing path, the method comprising:
(a) generating a PMTU discovery packet including an MTU information storage space in which a link MTU value of a link in the routing path between the source node and the destination node is stored;
(b) transmitting the generated PMTU discovery packet to the destination node; and
(c) if a response packet to the PMTU discovery packet from the destination node is received, changing the PMTU according to MTU information included in the response packet, wherein the link MTU value currently stored in the MTU information storage space of the PMTU discovery packet is compared with a link MTU value of a next-hop link which the PMTU discovery packet traverses, and the smaller one of the link MTU value currently stored in the MTU information storage space and the link MTU value of the next-hop link is stored in the MTU information storage space of the PMTU discovery packet.

2. The method of claim 1, wherein the PMTU discovery packet which is generated in step (a) is generated if a current PMTU value is maintained for a predetermined time.

3. The method of claim 1, wherein the PMTU discovery packet is equal to or smaller than the current PMTU in size.

4. The method of claim 1, wherein in step (a) a next-hop link MTU value of the source node is stored in the MTU information storage space.

5. The method of claim 1, wherein step (c) comprises step (c1) which if the PMTU discovery packet arrives at the destination node, a packet including the link MTU value stored in the MTU information storage space of the PMTU discovery packet is generated, and the packet is transmitted to the source node.

6. The method of claim 1, wherein the PMTU discovery packet complies with Internet Protocol version 6 (IPv6) and has a hop-by-hop option header that is an extension header.

7. The method of claim 6, wherein the hop-by-hop option header of the PMTU discovery packet includes an option type field which stores information indicating that the PMTU discovery packet should be discarded if a node in the routing path does not recognize the option type of the PMTU discovery packet.

8. The method of claim 7, wherein the information indicating that the PMTU discovery packet should be discarded is the highest 2 bits stored in the option type field.

9. The method of claim 7, wherein the option type field stores information indicating whether the link MTU value stored in the MTU information storage space can be changed.

10. The method of claim 9, wherein the information indicating whether the link value stored in the MTU information storage space can be changed is the third highest bit stored in the option type field.

11. The method of claim 1, wherein the MTU information is stored in an option data field in an option field of a hop-by-hop header of an Internet Protocol version 6 (IPv6) packet.

12. The method of claim 1, further comprising:
(d) if a response packet is not received for a predetermined time after transmitting the PMTU discovery packet to the destination node, transmitting a packet fragmented according to a predetermined PMTU value, to the destination node.

13. The method of claim 12, wherein the size of the predetermined PMTU value is a next-hop link MTU value of the source node.

14. The method of claim 12, further comprising:
(e) if an error message is received after transmitting the packet fragmented according to the predetermined PMTU value, fragmenting the packet again according to link MTU information included in the received error message and transmitting the packet.

15. The method of claim 14, wherein the error message is an Internet Control Message Protocol (ICMP) error message of Internet Protocol version 6 (IPv6) which uses one of numbers 0 to 127 in a “Type” field.

16. The method of claim 15, wherein the error message is an ICMP-Packet Too Big message.

17. The method of claim 12, further comprising:
(f) if the size of the packet transmitted in step (d) is greater than a next-hop link MTU value of a node in the routing path, generating at the node an error messagewhich is transmitted to the source node, and generating at the node a test message of the size of the next-hop link MTU value of the nodewhich is transmitted to the destination node.

18. The method of claim 17, wherein the test message is an Internet Control Message Protocol (ICMP) information message of Internet Protocol version 6 (IPv6) which uses one of numbers 128 to 255 in a “Type” field.

19. The method of claim 17, wherein the test message generated in step (f) includes source address and destination address information of the packet received by the node, and next-hop link MTU information of the node.

20. The method of claim 17, further comprising:
(g) if the packet received by the node is a test message generated by a previous node in the routing path, storing MTU information, source address information, and destination address information included in the received packet.

21. The method of claim 20, further comprising:
(h) comparing the MTU information, source address information, and destination address information included in a packet received after transmitting the error message generated in step (f) to the source node, with the MTU information, source address information, and destination address information stored in step (g), and if the information in each of the comparison is the same, discovering the packet received after transmitting the error message generated in step (g) without generating the error message and the test message.

22. An apparatus for changing a path maximum transmission unit (PMTU) of a routing path between a source node and a destination node on a dynamic IP network, wherein the routing path includes a plurality of links and the PMTU corresponds to a minimum link maximum transmission unit (MTU) of the links in the routing path, the apparatus comprising:
a PMTU discovery packet generation unit which generates a PMTU discovery packet having an MTU information storage space in which a link MTU value of a link in the routing path between the source node and the destination node is stored;
a transmission unit which transmits the generated PMTU discovery packet to the destination node; and
a PMTU changing unit, which if a response packet to the PMTU discovery packet from the destination node is received, changes the PMTU according to MTU information included in the response packet,
wherein the link MTU value currently stored in the MTU information storage space of the PMTU discovery packet is compared with a link MTU value of a next-hop link which the PMTU discovery packet traverses, and the smaller one of the link MTU value currently stored in the MTU information storage space and the link MTU value of the next-hop link is stored in the MTU information storage space of the PMTU discovery packet.

23. The apparatus of claim 22, wherein the PMTU discovery packet generation unit generates the PMTU discovery packet if the current PMTU value is maintained for a predetermined time.

24. The apparatus of claim 22, wherein the PMTU discovery packet is equal to or smaller than the size of the current PMTU in size.

25. The apparatus of claim 22, wherein a next-hop link MTU value of the source node is stored in the MTU information storage space.

26. The apparatus of claim 22, wherein if the PMTU discovery packet arrives at the destination node, a packet including the link MTU value stored in the MTU information storage space of the PMTU discovery packet is generated and transmitted to the source node.

27. The apparatus of claim 22, wherein the PMTU discovery packet is a packet which complies with Internet Protocol version 6 (IPv6) and has a hop-by-hop option header that is an extension header.

28. The apparatus of claim 27, wherein the hop-by-hop option header of the PMTU discovery packet includes an option type field which stores information indicating that the PMTU discovery packet should be discarded if a node in the middle of a routing path does not recognize the option type of the PMTU discovery packet.

29. The apparatus of claim 28, wherein the information indicating that the PMTU discovery packet should be discarded is the highest 2 bits stored in the option type field.

30. The apparatus of claim 28, wherein the option type field stores information indicating whether the link MTU value stored in the MTU information storage space can be changed.

31. The apparatus of claim 30, wherein the information indicating whether the link value stored in the MTU information storage space can be changed is the third highest bit stored in the option type field.

32. The apparatus of claim 22, wherein the MTU information is stored in an option data field in an option field of a hop-by-hop header of an Internet Protocol version 6 (IPv6) packet.

33. The apparatus of claim 22, wherein if a response packet is not received for a predetermined time after transmitting the PMTU discovery packet to the destination node, a packet fragmented according to a predetermined PMTU value is transmitted to the destination node.

34. The apparatus of claim 33, wherein the size of the predetermined PTMU value is a next-hop link MTU value of the source node.

35. The apparatus of claim 33, wherein if an error message is received after transmitting the packet fragmented according to the predetermined PMTU value, the packet is fragmented again according to link MTU information included in the received error message and is transmitted.

36. The apparatus of claim 35, wherein the error message is an Internet Control Message Protocol (ICMP) error message of Internet Protocol version 6 (IPv6) which uses one of numbers 0 to 127 in a “Type” field.

37. The apparatus of claim 35, wherein the error message is an ICMP-Packet Too Big message.

38. The apparatus of claim 33, wherein if the size of the transmitted packet is greater than a next-hop link MTU value of a node in the routing path, the node generates an error message, transmits the generated error message to the source node, generates a test message of the size of the next-hop link MTU value of the node, and transmits the generated test packet to the destination node.

39. The apparatus of claim 38, wherein the test message is an Internet Control Message Protocol (ICMP) information message of Internet Protocol version 6 (IPv6) which uses one of numbers 128 to 255 in a “Type” field.

40. The apparatus of claim 38, wherein the generated test message includes source address and destination address information of the packet received by the node and next-hop link MTU information of the node.

41. The apparatus of claim 38, wherein if the packet received by the node is a test message generated by a previous node in the routing path, MTU information, source address information, and destination address information included in the received packet are stored.

42. The apparatus of claim 42, wherein the MTU information, source address information, and destination address information included in a packet, which is received after transmitting the generated error message to the source node, are compared with the stored MTU information, source address information, and destination address information, and if the information in each of the comparison is the same, discovering the packet received after transmitting the error message generated without generating the error message and the test message.
